(19) United States
(12) Patent Application Publication
(10) Pub. No.: US 2014/0278301 A1
(43) Pub. Date: Sep. 18, 2014

(54) SYSTEM AND METHOD FOR GENERATING A PARALLEL PROCESSING APPROXIMATION MODEL

(71) Applicant: Kevin D. Howard, Tempe, AZ (US)

(72) Inventor: Kevin D. Howard, Tempe, AZ (US)

(21) Appl. No.: 14/207,228

(22) Filed: Mar. 12, 2014

Related U.S. Application Data
(60) Provisional application No. 61/777,382, filed on Mar. 12, 2013.

(51) Int. Cl. G06F 17/50

(52) U.S. Cl. CPC G06F 17/5009
USPC 703/2

(57) ABSTRACT

A parallel processing approximation model is automatically generated via a method including generating a time complexity search table including a plurality of columns and rows, each header of the column defining a polynomial which defines the algorithmic time complexity or overhead time complexity, and each row within the column defining the respective polynomial for a plurality of dataset divisions or size multiplications. The method further includes generating a comparison column and determining an approximation column having the highest algorithmic time complexity values that do not exceed the time complexity comparison column.

### RELATED APPLICATIONS

This application claims priority to U.S. Provisional Application Ser. No. 61/777,382 entitled “System and Method for Generating a Parallel Processing Approximation Model”, filed Mar. 12, 2013.

### BACKGROUND

Parallel processing is the process of dividing a program, or serial code, into multiple computational threads and processing each computational thread using a different processing element, i.e. a processor. As technology advances, computers are being generated with multiple processing cores to enable parallel processing.

Writing parallel processing code is very difficult because a great deal of effort must be expended without knowing the value of that effort. Traditionally, there are two laws concerning parallel processing: Amdahl's Law (Gene M. Amdahl, “Validity of the Single Processor Approach to Achieving Large Scale Computing Capabilities”, AFIPS Spring Joint Computer Conference, 1967) and Gustafson's Law (John L. Gustafson, “Reevaluating Amdahl's Law”, Communications of the ACM 31(5), 1988, 532-533). Neither Amdahl's Law, nor Gustafson's Law is predictive prior to parallelization to predict speedup performance of an algorithm for different dataset sizes. For example, in the case where the processing time is homogeneous for some given dataset size, it is still necessary to execute the algorithm with that dataset size before it is possible to know the performance of the algorithm at that dataset size, also called “profiling”.

Additionally, parallel processing divides the dataset across multiple computational elements meaning the dataset size per computational element changes with the number of computational elements. Therefore, the prior art requires profiling not only the different dataset sizes, as discussed above, but also the number of processing elements used in the parallel processing as well.

Typical prior art requires parallelizing the algorithm a priori to profiling for the various multi-computational element cases. This requirement does not allow for predicting the parallel performance prior to generating the parallel code, and therefore a great deal of effort must be expended without knowing the value of that effort.

Strong scaling speedup is governed by Amdahl's Law. Prior art consensus is that strong scaling speedup is primarily a function of the serial portion of an algorithm. Moreover, further consensus in the prior art is that strong scaling speedup is, with certain hardware exceptions, linear at best.

### SUMMARY

In one aspect of the disclosure is described a method for generating a prediction of algorithmic time complexity of parallel processing of an algorithm having a dataset capable of being subdivided, using a system that includes a processor and memory, the method includes the steps of: generating a time complexity search table that includes a plurality of columns and a plurality of rows, each column including an approximation header defining a polynomial which defines the algorithmic time complexity and each row of each column defining the algorithmic time complexity value of the respective polynomial for a plurality of dataset multiplications; generating a time complexity comparison column defining plurality of values of the wall clock time required to execute the algorithm for the plurality of dataset multiplications; determining a time complexity approximation column within the time complexity search table defining the column having the highest algorithmic time complexity values that do not exceed the values of the time complexity comparison column; storing the header of the time complexity approximation column within the memory; and generating a time complexity approximation model output that includes the header of the time complexity approximation column stored within the memory.

In another aspect of the disclosure is described a method for generating a prediction of algorithmic overhead of parallel processing of an algorithm having a dataset capable of being subdivided, using a system comprising a processor and memory, the method comprising: generating an overhead time complexity search table comprising a plurality of columns and a plurality of rows, each column comprising an approximation header defining a polynomial which defines an overhead time complexity of the algorithm and each row of each column defining the algorithmic overhead time complexity value of the respective polynomial for a plurality of dataset divisions; generating an overhead comparison column defining plurality of values of the additional overhead wall clock time required to execute the algorithm for the plurality of dataset divisions; determining an overhead time complexity approximation column within the overhead search table defining the column having the highest algorithmic overhead time complexity values that do not exceed the values of the overhead time complexity comparison column; storing the header of the overhead time complexity approximation column within the memory; and generating an overhead time complexity approximation model output comprising the header of the overhead time complexity approximation column stored within the memory.

### BRIEF DESCRIPTION OF THE FIGURES

FIG. 1 depicts an exemplary system for generating parallel processing performance approximation model, particularly a time complexity determination model output, in one embodiment.

FIG. 2 shows an exemplary wall clock time complexity search table, in one embodiment.

FIG. 3 shows an exemplary wall clock time complexity comparison column, in one embodiment.

FIG. 4 shows an exemplary comparison between the wall clock time complexity comparison column of FIG. 3 and the wall clock time complexity search table of FIG. 2.

FIG. 5 depicts an exemplary method for generating a time complexity determination model output, in one embodiment.

FIG. 6 depicts an exemplary comparison between the wall clock time complexity comparison column of FIG. 3 and a speedup approximation column to generate an additional time complexity comparison column.

FIG. 7 shows a comparison between the additional time complexity comparison column of FIG. 6 and the wall clock time complexity search table of FIG. 2.

FIG. 8 depicts a system for generating an overhead approximation model output, in one embodiment.

FIG. 9 shows an exemplary overhead time complexity search table, in one embodiment.

FIG. 10 shows an exemplary overhead observed time column, in one embodiment.

FIG. 11 shows an exemplary comparison between the overhead observed time column of FIG. 10 and the overhead time complexity search table of FIG. 9.

FIG. 12 depicts an exemplary method for generating an overhead approximation model output, in one embodiment.

FIG. 13 depicts an exemplary comparison between the overhead observed time column of FIG. 10 and an overhead approximation column to generate an additional overhead comparison column.

FIG. 14 shows an exemplary comparison between the additional overhead comparison column of FIG. 13 and the overhead time complexity search table of FIG. 9.

FIG. 15 shows an exemplary parallel processing performance model generator (PPPMG), in one embodiment.

FIG. 16 depicts an exemplary method for generating the processing performance model output of FIG. 15, in one embodiment.

### DETAILED DESCRIPTION OF THE DRAWINGS

Reference is now made to the figures wherein like parts are referred to by like numerals throughout. Referring generally to the figures, the present invention includes a device and method for predicting the parallel performance of a given algorithm before the algorithm is parallelized. A device according to an embodiment of the present invention may take any form. For example, a device may take the form of a personal computer, handheld device, cellular telephone, or the like.

The embodiments discussed below show that, for data parallel algorithms, it is possible to automatically generate an algorithm unique performance model, which is executed using only one computational element, that is able to predict the parallel performance of the algorithm for any dataset size or any number of parallel computational elements.

The embodiments below describe systems and methods for generating a parallel performance model by determining one or more of: algorithm-processing “wall clock time” and “overhead”, as opposed to the serialism/parallelism paradigm that currently exists in the prior art. The term “wall clock time,” as used herein, defines the elapsed time as determined by a wall clock (e.g. nanoseconds, milliseconds, seconds), as opposed to time measured by microprocessor clock pulses or cycles (e.g. “n” number of clock cycles). For purposes herein, the term “time” as used hereinafter is interchangeable with “wall clock time”. The term “overhead,” as used herein, defines any combination of excess or indirect computation time, memory, bandwidth, or other resources that are required to attain a particular goal.

Speedup may be shown as a concept of the wall-clock processing time of an algorithm. For example, the algorithm, represented by “Tₐ”, may have a dataset size “d”. The well-known Amdahl's Law is:

$${Amdahl}^{′} s Law \text{:} \\ S ( n ) = \frac{1}{( 1 - p ) + \frac{p}{n}} \qquad Equation 1$$

where p=processing time for the parallelizable portion of an algorithm and n=the number of processing elements.

Examining speedup without the serial speedup effects means p=1. Therefore, the maximum parallel performance of the function highlights an underlying premise of Amdahl's Law:

$$Maximum Parallel Performance of an Algorithm \text{:} \\ {S}_{n} = \frac{{T}_{1}}{{T}_{n}} ⇒ Max ( S ( n ) ) = \frac{1}{\frac{1}{n}} = n ; \qquad Equation 2$$

where Tₙ=processing time for an algorithm with n processing elements and Max(S(n))=maximum value of S(n).

However, the relationship Tₙ=p/n only holds if the time complexity of the function is O(n). That is, the algorithm work changes linearly with dataset size, which is not the general case. Time complexity is the relationship of a functions processing time to its input dataset size, as discussed in Paul E. Black, “big-O Notation”, in Dictionary of Algorithms and Data Structures [online], Paul E. Black, ed., U.S. National Institute of Standards and Technology. 11 Mar. 2005. Because the time complexity of a function is rarely linear, a more general equation, using time complexity is required. Such equation is as follows:

$$General Maximum Parallel Performance of an Algorithm \text{:} \\ {S}_{n} = \frac{{T}_{1}}{{T}_{n}} ⇒ Max ( S ( d , n ) ) = \frac{T ( d )}{T ( \frac{d}{n} )} \qquad Equation 3$$

where T(d)=Time complexity for a function with an input data set size of d.

### Exploration of Max(S(d, n))

Given a hypothetical relationship T(d)=d^{x}, where n=2, we can now examine various Max(S(d, n)) values as “x” is varied.

Equations 4(a) through 4(g) show exemplary parallel processing effects of changing dataset size “d”. For example, if the wall-clock processing time of T grows as the value of the dataset size “d” increases, then the relationship between d and d/2 may be shown by Equation 4(a), below.

$$\begin{matrix}Superlinear Negative Speedup \text{:} \\ if T ( d ) = \frac{1}{{d}^{2}} ; \\ and {T}^{′} ( \frac{d}{2} ) = \frac{{2}^{2}}{d} ; \\ then speedup = \frac{T ( d )}{{T}^{′} ( \frac{d}{2} )} = \frac{\frac{1}{{d}^{2}}}{\frac{{2}^{2}}{d}} = \frac{1}{4} = .25 & Equation 4 ( a ) \\ Linear Negative Speedup \text{:} \\ if T ( d ) = \frac{1}{d} ; \\ and {T}^{′} ( \frac{d}{2} ) = \frac{2}{d} ; \\ then speedup = \frac{T ( d )}{{T}^{′} ( \frac{d}{2} )} = \frac{\frac{1}{d}}{\frac{2}{d}} = \frac{1}{2} = .5 & Equation 4 ( b ) \\ Sublinear Negative Speedup \text{:} \\ if T ( d ) = \frac{1}{{d}^{0.5}} ; \\ and {T}^{′} ( \frac{d}{2} ) = {( \frac{2}{d} )}^{0.5} ; \\ then speedup = \frac{T ( d )}{{T}^{′} ( \frac{d}{2} )} = \frac{\frac{1}{{d}^{0.5}}}{\frac{1.414}{{d}^{0.5}}} = .707 & Equation 4 ( c )\end{matrix}$$

Equations 4(a)-4(c) show an inverse relationship between the input dataset size and the processing time of the algorithm which is not possible. If it were possible, then only negative maximum speedup would result.

$$No speedup \text{:} \\ if T ( d ) = {d}^{0} ; \\ and \\ {T}^{′} ( \frac{d}{2} ) = {( \frac{d}{2} )}^{0} ; \\ then speedup = \frac{T ( d )}{{T}^{′} ( \frac{d}{2} )} = \frac{{d}^{0}}{{( \frac{d}{2} )}^{0}} = 1 \qquad Equation 4 ( d )$$

Equation 4(d) results in no speedup. Instead, processing time is independent of dataset size, which is equivalent to saying that the function is serial.

$$Sublinear Positive Speedup \text{:} \\ if T ( d ) = {d}^{0.5} ; \\ and \\ {T}^{′} ( \frac{d}{2} ) = {( \frac{d}{2} )}^{0.5} ; \\ then speedup = \frac{T ( d )}{{T}^{′} ( \frac{d}{2} )} = \frac{{d}^{0.5}}{{( \frac{d}{2} )}^{0.5}} = 1.414 \qquad Equation 4 ( e )$$

Equation 4(e) describes a function whose time complexity is O(n^{0.5}) which generates only weak maximum speedup.

$$Linear Speedup \text{:} if {T}_{a} ( d ) = d ; \\ and \\ {T}_{a}^{′} ( \frac{d}{2} ) = ( \frac{d}{2} ) ; \\ then speedup = \frac{{T}_{a} ( d )}{{T}_{a}^{′} ( \frac{d}{2} )} = \frac{d}{( \frac{d}{2} )} = 2 \qquad Equation 4 ( f )$$

Equation 4(f) describes a function whose time complexity is O(n), linear maximum speedup. This is the special case described by Amdahl's law.

$$Superlinear Speedup \text{:} \\ if {T}_{a} ( d ) = {d}^{2} ; \\ and \\ {T}_{a}^{′} ( \frac{d}{2} ) = {( \frac{d}{2} )}^{2} ; \\ then speedup = \frac{{T}_{a} ( d )}{{T}_{a}^{′} ( \frac{d}{2} )} = \frac{{d}^{2}}{{( \frac{d}{2} )}^{2}} = 4 \qquad Equation 4 ( g )$$

Equation 4(g) describes a function whose time complexity is O(n²). Therefore, it appears that superlinear maximum speedup can arise directly from a function whenever its time complexity is greater than O(n).

### Time Complexity Determination:

FIG. 1 depicts a system 100 for generating a time complexity determination output 118. FIG. 2 shows an exemplary time complexity determination search table 114. FIG. 3 shows an exemplary observed time column 116. FIG. 4 shows an exemplary comparison 400 between the observed time column 116 and the time complexity determination search table 114. FIG. 5 depicts an exemplary method 500 for generating time complexity determination output 118. FIG. 6 depicts an exemplary comparison between observed time column 116 and a time complexity determination search table column to generate an additional approximation column 600. FIG. 7 shows an exemplary comparison between the additional comparison column 600 and the time complexity determination search table 114. FIGS. 1-7 are best viewed together in the following description.

System 100 includes a computer 102 having a processor 104 in communication with memory 106, and a display 120.

Display 120 may represent any medium for displaying information to a user. For example, display 120 may represent one or more of a liquid-crystal display (LCD), a cathode ray tube (CRT), plasma, light emitting diode (LED), or a printer that displays printed information to a user.

Memory 106 may represent one or more of random access memory (RAM), read only memory (ROM), electrically erasable programmable read-only memory (EEPROM), FLASH memory, magnetic storage (e.g., a hard disk drive), and optical storage (e.g., CDROM and/or DVD drive. Memory 106 is illustratively shown storing algorithm 108, time complexity determination generator 112, and time complexity determination output 118.

Algorithm 108 is an algorithm for processing a dataset. Algorithm 108 is capable of being parallel processed, i.e., the dataset 110 may be divided into multiple sections, each of which may be processed by one of a plurality of processing elements, thereby reducing the dataset size per processing element. For example, algorithm 108, when executed by processor 104, processes dataset 110 having a dataset size “n”. Dataset 110 of size n may represent the dataset size of a serial code of the algorithm 108 (i.e. the dataset size before dividing).

Time complexity determination generator 112 (TCDG) includes time complexity search table 114 and observed time table 116. For example, TCDG 112 is stored in memory 106 as computer readable instructions that when executed by processor 104 generates time complexity determination output 118 (TCDO) using a single processor 104. TCDG 112 may be a separate application running on computer 102, or may be, for example, a plug-in running in conjunction with a program installed on computer 102. In certain embodiments, TCDG 112 may be located on a separate computer, wherein the algorithm 108 and dataset 110 information is transferred over a network to the separate computer for analyzing.

TCDG 112 utilizes the concept of determining the observed time it takes for algorithm 108 to process the dataset for a plurality of dataset sizes, and then comparing the observed time to a generated time complexity search table to approximate the algorithmic time complexity of the algorithm.

Since, in the absence of serialism, the time complexity of a function defines its maximum speed up, finding T(d) is of primary importance. T(d) may be found by searching a table containing target time complexity functions and their time values for different dataset sizes.

In one embodiment, TCDG 112 generates a time complexity search table 114, for example, as shown in FIG. 2. In another embodiment, time complexity search table 114 is predetermined and stored within memory 106. Time complexity search table 114 includes a plurality of columns 202 and a plurality of rows 204. The quantity of columns 202 and rows 204 may vary as needed. Rows 204 represent each value of “x”, wherein the dataset size of an algorithm is multiplied by “x”. Column headers 206 show examples of the possible terms (i.e. d⁰, d¹ . . . d^{y}) used to define a polynomial which defines the time complexity equation. The values found in the body of each column 202 are computed, using the dataset size “d”, and the multiplication of that dataset by “x” according to function t(d). Each dataset size can be considered a data point on the curve formed by the proposed time complexity function. To obtain a good function fit, the number of data points searched may be one plus the number of inflection points generated by the proposed time complexity function. Although the dataset can be of any size, the example used herein uses a dataset size “d” of 1. To obtain different datapoints and thus form the table rows, the value of “d” is multiplied by some value of “x” for the row, showing the effects of dataset size variation. The timing, versus its time complexity, is given by t(d). It should be appreciated by one in skilled in the art that column headers 206 may be any monotonically defined function, not just a power function as illustrated.

TCDG 112, of FIG. 1, may also generate observed time table 116. For example, a single processor 104 executes TCDG 112 instructions to multiply the dataset size of dataset 110 by “x” and compute the time it takes to execute each size dataset for each “x”.

FIG. 3 shows an exemplary observed time table 302 including observed time column, in one embodiment. For example, cell 302 is calculated by TCDG 112 by multiplying the dataset 110 by two and executing the algorithm with twice the dataset size. TCDG 112 repeats this process in order to generate cells 304 and 306 each representing the wall clock time it takes to execute the dataset 110 with three times the dataset size and four times the data set size, respectively. In one embodiment, observed time column 116 is generated using a single processor, for example processor 104. One skilled in the art will appreciate that wall clock speedup comparison column may contain more or less rows than depicted in FIG. 3.

TCDG 112 utilizes time complexity determination search table 114 and observed time column 116 to generate the time complexity determination output 118. For example, after generating observed time table 116, TCDG 112 analyzes the observed time column 116 and determines the closest match to a particular approximation column within the time complexity determination search table 114 that does not exceed the values of the observed time column 116. This approximation column indicates the highest power of the polynomial which defines the time complexity of the algorithm. For example, using the values shown in FIGS. 2 and 3, FIG. 4 shows that the approximation column as column 208 (i.e. the d⁴ column).

This process may be repeated to allow for progressively closer approximation by (i) storing the approximation column header in approximation header data 122, (ii) subtracting the approximation column from the observed time column 116 to generate an additional observed time column, (iii) determining an additional approximation column, (iv) repeating (i)-(iii) until the additional approximation column equals the additional observed time column, and (v) outputting the sum of all of the approximation column headers in approximation column header data 122 to define the time complexity determination output 118. The generated time complexity determination output 118 thereby comprises the following time complexity model which allows the user to approximate the function T(d):

$$Time Complexity Model \text{:} \\ T ( d ) ≅ {f}_{1} ( d ) + {f}_{2} ( d ) + … + {f}_{m} ( d ) = {\sum }_{i = 1}^{m} {f}_{i} ( d ) \qquad Equation 5$$

wherein “fᵢ” is the highest power found in the time complexity determination search table 114 for the i^{th} speedup term which approximates the time complexity value without exceeding that value; “m” is the number of search iterations performed; and all calculations are performed by changing the dataset size, with no change to the algorithm. Thus, it is possible to obtain an approximation of the time complexity determination model of the algorithm 108, without parallelization.

FIG. 5 depicts an exemplary method 500 for generating algorithmic speedup approximation model 118. For example, method 500 is implemented as time complexity determination generator 112 of system 100, FIG. 1.

In step 502, TCDG 112 generates a time complexity determination search table. In one example of step 502, processor 104 executes machine readable instructions of TCDG 112 to calculate a plurality of columns 202 and rows 204 that form the time complexity determination search table 114.

In step 504, TCDG 112 generates the observed time column 116 as depicted in FIGS. 1-4. For example, TCDG 112 may multiply the dataset in two, and then execute the algorithm with twice the dataset size to determine the time it takes to execute the algorithm with half the dataset. This may be repeated a plurality of times to generate multiple rows in the wall clock speedup comparison column (i.e. the time it takes to execute the algorithm with three times the dataset, four times the dataset, etc.)

In step 506, TCDG 112 determines an approximation column within the time complexity determination search table generated in step 502 with the highest values that do not exceed the values of the observed time column generated in step 504. For example, in the example depicted in FIGS. 2-4, the approximation column is column 208.

In step 508, TCDG 112 stores the header of the approximation column determined in step 506 in memory. Using the example in FIGS. 2-4, TCDG 112 may store “d⁴” in approximation header data 122 of system 100.

In step 509, TCDG 112 determines if the speedup approximation column determined in step 506 is equal to the observed time column determined in step 504. If equal, method 500 proceeds with step 518. If not equal, method 500 proceeds with step 510.

Step 510 is optional. If included, in step 510, TCDG 112 subtracts the approximation column values determined in step 506 from the values of the observed time comparison column determined in step 504 to determine an additional observed time column. For example, TCDG 112 may subtract the values of “d⁴” from the values of observed time column 116 depicted in FIG. 3, and then update the values of observed time column 116 in memory 106 to generate a new/additional observed time column. FIG. 6 shows an exemplary additional observed time column 600 using the values depicted in FIGS. 2-4.

Step 512 is optional. If included, in step 512, TCDG 112 determines an additional approximation column of the time complexity determination search table from step 502 with the highest values that do not exceed the values of the additional observed time column determined in step 510. In one example, TCDG 112 analyzes the values of the time complexity determination search table 114 to generate an additional approximation column in the table 114 that has the highest values that do not exceed the values of the additional observed time column 600. FIG. 7 depicts the additional approximation column 700 when compared to the values depicted in FIGS. 2-6. In this example, additional approximation column 700 is the same as the “d²” column (i.e. column 210) of FIG. 2.

Step 514 is optional. If included, in step 514, TCDG 112 stores the header of the additional approximation column determined in step 506 in memory. For example, continuing with the examples depicted in FIGS. 2-7, TCDG 112 may store “d²” in approximation header data 122 of system 100. The approximation header data 122 would now contain two data pieces: the original approximation column header “d⁴”, and the additional approximation column header “d²”.

Step 516 is optional. If included, in step 516, TCDG 112 determines if the additional approximation column determined in step 512 is equal to the additional observed time column determined in step 510. If equal, method 500 proceeds with step 518. If not equal, method 500 proceeds with step 510 thereby creating a repeating process that repeats until an additional observed time column equals a column in the time complexity determination search table. For example, as shown in FIG. 7, the additional observed time column 600 values are {x(2)=4, x(3)=9, x(4)=16} and the additional speedup approximation column 700 values are also {x(2)=4, x(3)=9, x(4)=16}.

Optional steps 510-516 allow for progressively closer approximation of the time complexity determination model. For example, as the steps repeat until a predefined threshold defining the difference required, between the between the additional approximation column and the additional observed time column, to determine when the time complexity determination model is adequate when the additional approximation column is not equal to the additional observed time column in step 516, the method determines an additional approximation column header, thereby progressively improving the approximation. Accordingly, where step 516, or step 509 results in an “equal” determination, the approximation model output will be the maximum speedup approximation model.

In step 518, the time complexity determination model is output. In one embodiment, TCDG 112 takes all values of the column headers stored within the approximation column header data and outputs them as an equation representing speedup approximation model 118. For example, using the values and example depicted in FIGS. 2-7, time complexity determination model 118 would be: T(d)=d⁴+d². The time complexity determination model may be output by being displayed on display 120 of computer 102. Alternatively, the time complexity determination model may be transmitted to a remote user over a network (not shown).

### Overhead Approximation Model Output Generation:

Parallel processing means that the processing is spread over multiple, simultaneously executing processing elements. Spreading the processing may generate overhead. This overhead has the effect of decreasing the effect of

$$T ( \frac{d}{n} )$$

of Equation 3, above. It is possible for there to be no overhead, but any existing overhead tends to grow as a function of the number of processing elements. Overhead time complexity is a different function than time complexity. The relationship between processing element count and dataset size is given by the overhead time-complexity equation, below:

Equation 6: Overhead Time Complexity:

Tₒ(d,n)=0VTₒ(nd)

where Tₒ(d, n)=overhead time complexity for an algorithm with dataset size “d” for ‘n” processing elements.

Approximating the overhead time complexity is achieved in a manner similar to approximating the time complexity as discussed above with reference to FIGS. 2-7. That is, a time complexity search table is constructed, followed by the construction of an observed overhead time table, followed by a search of the time complexity search table using the observed overhead time table, and finally, summing together the found overhead time complexity headers. Overhead consists of any non-function-required data movement or processing. That is, processing or data movement that is only required to process on multiple processing elements.

FIG. 8 depicts a system for generating an overhead time complexity model output. FIG. 9 shows an exemplary overhead time complexity search table 814. FIG. 10 shows an exemplary overhead observed time column 816. FIG. 11 shows an exemplary comparison between the overhead observed time column 816 and the overhead time complexity search table 814. FIG. 12 depicts an exemplary method 1200 for generating an overhead time complexity model output. FIG. 13 depicts an exemplary comparison between the overhead observed time column 816 and an overhead time complexity approximation column 908 to generate an additional overhead observed time column 1300. FIG. 14 shows an exemplary comparison between the additional overhead observed time column 1300 and the overhead time complexity search table 814. FIGS. 8-14 are best viewed together with the following description.

System 800 includes a computer 802 having a processor 804 in communication with memory 806, and a display 820.

Display 820 may represent any medium for displaying information to a user. For example, display 820 may represent one or more of a liquid-crystal display (LCD), a cathode ray tube (CRT), plasma, light emitting diode (LED), or a printer that displays printed information to a user.

Memory 806 may represent one or more of random access memory (RAM), read only memory (ROM), electrically erasable programmable read-only memory (EEPROM), FLASH memory, magnetic storage (e.g., a hard disk drive), and optical storage (e.g., CDROM and/or DVD drive. Memory 806 is illustratively shown storing algorithm 808, overhead time complexity model generator 812, and overhead time complexity model output 818.

Algorithm 808 is an algorithm for processing a dataset 810. Algorithm 808 is capable of being parallel processed, wherein dataset 810 may be divided into multiple sections, each of which is processed by one of a plurality of processing elements, thereby reducing the dataset size per processing element. For example, algorithm 808, when executed by processor 804, processes dataset 810 having a size “d”. Dataset 810 of size “d” may represent the dataset size of a serial code of the algorithm 808 (i.e. the dataset size before dividing).

Computer 802, processor 804, memory 806, algorithm 808 and dataset 810 may be the same as computer 102, processor 104, memory 106, algorithm 108 and dataset 110 as depicted in FIGS. 1-7.

Overhead time complexity model generator 812 (OTCMG0) includes overhead time complexity search table 814 data and overhead observed time column 816 data. For example, OTCMG 812 is stored in memory 806 as computer readable instructions that when executed by processor 804 generates overhead time complexity model output 818 (OTCMO) using a single processor 804. OTCMG 812 may be a separate application running on computer 802, or may be, for example, a plug-in running in conjunction with a program installed on computer 802. In certain embodiments, OTCMG 812 may be located on a separate computer (not shown), wherein the algorithm 808 and dataset 810 information is transferred over a network to the separate computer for analyzing. OTCMG 812 may utilize the concept shown above describing Equations 4-6 to determine the OTCMO 818.

In one embodiment, OTCMG 812 generates overhead time complexity search table 814. In another embodiment, overhead time complexity search table 814 is predetermined and stored within memory 806.

FIG. 9 shows an exemplary overhead time complexity search table 814. Overhead time complexity search table 814 includes a plurality of columns 902 and a plurality of rows 904. The quantity of columns 902 and rows 904 may vary as needed. Rows 904 represent each value of “x”. Column headers 906 show examples of the possible terms to be used in the polynomial (i.e. d⁰, d¹ . . . dⁿ) which will define the overhead time complexity the algorithms. The values found in the body of each column 902 are computed, for example, using the dataset size “d” and the number of computational elements “n”. The number of columns represent the number of searchable functions so adding a column requires adding a new, different, searchable function. Conversely deleting a column means removing a searchable function. Further, it is clear that if there is only one computational element, then there may be no data division, thus there is at least one division which occurs between two computational elements. One skilled in the art will appreciate that there may be more or fewer-columns and rows than what is depicted in FIG. 9.

OTCMG 812, of FIG. 8, may additionally generate an overhead observed time column 816. For example, a single processor 804 executes OTCMG 812 instructions to calculate multiple values of “n” (i.e. multiple processing elements) and compute overhead per each additional value of “n”, for example, using a loopback test.

FIG. 10 shows an exemplary overhead observed time column 816. For example, cell 1002 is calculated by OTCMG 812 by calculating, using a loopback test (i.e. taking a single communication channel from a single processing element through a single network interface card to a switch fabric and then back), the overhead for the algorithm using “two” processing elements. OTCMG 812 repeats this process in order to generate cells 1004 and 1006 each representing the overhead observed time using three and four processing elements, respectively. The generation of overhead observed time column 816 is completed using a single processor, for example processor 804. One skilled in the art will appreciate that overhead observed time column 816 may contain more or less rows than what is depicted in FIG. 10.

OTCMG 812 utilizes overhead time complexity search table 814 and overhead observed time column 816 to generate the overhead time complexity model output 818. For example, after generating overhead observed time column 816, OTCMG 812 analyzes the overhead comparison column 816 and determines the closest match to a particular overhead approximation column within the overhead time complexity search table 814 that does not exceed the values of the overhead comparison column 816. This overhead approximation column indicates the highest power of the function which approximates the actual algorithmic overhead. For example, using the values shown in FIGS. 9 and 10, FIG. 11 shows that the overhead approximation column is column 1008 (i.e. the d² column).

This process may be repeated to allow for progressively closer approximation by (i) storing the approximation column header in overhead approximation header data 822, (ii) subtracting the overhead approximation column from the overhead comparison column 816 to generate an additional overhead comparison column, (iii) determining an additional overhead approximation column, (iv) repeating (i)-(iii) until the additional overhead approximation column equals the additional overhead comparison column, and (v) outputting the sum of all of the overhead approximation column headers in approximation column header data 822 as the overhead time complexity model output 818. The generated overhead time complexity model output 818 thereby comprises the following algorithm overhead time complexity model which allows the user to know the parallel overhead of an algorithm before that algorithm is parallelized:

$$Overhead Time Complexity Approximation Model \text{:} \\ \begin{matrix}{T}_{o} ( nd ) ≅ 0 ⋁ ( {f}_{1} ( nd ) + {f}_{2} ( nd ) + … + {f}_{m} ( nd ) ) \\ = 0 ⋁ {\sum }_{l = 1}^{m} {f}_{{o}_{l}} ( nd )\end{matrix} \qquad Equation 8$$

wherein “fₗ” is the highest power found in the overhead time complexity determination search table 114 for the i^{th} speedup term which approximates the time complexity value without exceeding that value; “m” is the number of search iterations performed; and all calculations are performed by changing the number of processing elements “n” with no change to the algorithm.

FIG. 12 depicts an exemplary method 1200 for generating an algorithmic overhead time complexity model. For example, method 1200 is implemented using system 800 depicted in FIGS. 8-11 and generates the overhead time complexity model output 818.

In step 1202, OTCMG 812 generates an overhead time complexity search table. In one example of step 1202, processor 804 executes machine readable instructions (i.e. associated with OTCMG 812) that calculate a plurality of columns 902 and rows 904 that form the overhead time complexity search table 814.

In step 1204, OTCMG 812 generates the overhead observed time column 816 as depicted in FIGS. 8-11. For example, OTCMG 812 calculating, using a loopback test, the overhead for the algorithm using “two” processing elements. This may be repeated a plurality of times to generate multiple rows in the overhead observed time column.

In step 1206, OTCMG 812 determines an overhead approximation column within the overhead time complexity search table generated in step 1202 with the highest values that do not exceed the values of the overhead observed time column generated in step 1204. For example, in the example depicted in FIGS. 9-11, the overhead approximation column is column 908.

In step 1208, OTCMG 812 stores the header of the overhead approximation column determined in step 1206 in memory. For example, OTCMG 812 may store “d²” in overhead approximation header data 822 of system 800.

In step 1209, OTCMG 812 determines if the overhead approximation column determined in step 1206 is equal to the overhead comparison column determined in step 1204. If equal, method 1200 proceeds with step 1218. If not equal, method 1200 proceeds with step 1210.

Step 1210 is optional. If included, in step 1210, OTCMG 812 subtracts the overhead approximation column values determined in step 1206 from the values of the overhead observed time column determined in step 1204 to determine an additional overhead observed time column. For example, OTCMG 812 may subtract the values of “d²” from the values of overhead comparison column 816 depicted in FIG. 10, and then update the values of overhead comparison column 816 in memory 106 to generate a new/additional overhead comparison column. FIG. 13 shows an exemplary additional overhead comparison column 1300 using the values depicted in FIGS. 9-11.

Step 1212 is optional. If included, in step 1212, OTCMG 812 determines an additional overhead approximation column of the wall clock overhead approximation search table from step 1202 with the highest values that do not exceed the values of the additional overhead observed time column determined in step 1210. In one embodiment, OTCMG 812 may analyze the values of the additional wall clock overhead comparison 816 to an additional overhead approximation column in the table 814 that has the highest values that do not exceed the values of the additional overhead comparison column 1300. FIG. 14 depicts the additional overhead approximation column 1400 when compared to the values depicted in FIGS. 9-13. In this example, additional overhead approximation column 1400 is the same as the “d^{1/2}” column (i.e. column 910) of FIG. 9.

Step 1214 is optional. If included, in step 1214, OTCMG 812 stores the header of the additional overhead approximation column determined in step 1206 in memory. For example, continuing with the examples depicted in FIGS. 9-14, OTCMG 812 may store “d^{1/2}” in overhead approximation header data 822 of system 800. The overhead approximation header data 822 would now contain two data pieces: the original overhead approximation column header “d²”, and the additional overhead approximation column header “d^{1/2}”.

Step 1216 is optional. In step 1216, OTCMG 812 determines if the additional overhead approximation column determined in step 1212 is equal to the additional overhead comparison column determined in step 1210. If equal, method 1200 proceeds with step 1218. If not equal, method 1200 proceeds with step 1210 thereby creating a repeating process that repeats until an additional overhead comparison column equals a column in the overhead time complexity search table. For example, as shown in FIG. 14, the additional overhead comparison column 1300 values are {(N−1)(1)=1.414, (N−1) (2)=5.732, (N−1)(3)=2} and the additional overhead approximation column 1400 values are also {(N−1)(1)=1.414, (N−1) (2)=5.732, (N−1)(3)=2}. Alternatively, the steps may be repeated until the difference between the additional overhead approximation column 1400 and the additional overhead comparison column 1300 reaches a predetermined threshold.

Optional steps 1210-1216 allow for progressively closer approximation of the overhead time complexity model. For example, as the steps repeat until a predefined threshold defining the difference required, between the between the additional overhead approximation column and the additional overhead comparison column, to determine when the overhead time complexity model is adequate. When the additional overhead approximation column is not equal to the additional speedup comparison column in step 1216, the method determines an additional approximation column header, thereby progressively improving the approximation. Accordingly, where step 1216, or step 509 results in an “equal” determination, the overhead time complexity model output will be the maximum overhead time complexity model.

In step 1218, the overhead time complexity model is output. In one embodiment, OTCMG 812 takes values of the overhead approximation column headers stored within the approximation column header data and outputs them as an equation representing overhead time complexity model 818. For example, using the values and example depicted in FIGS. 9-14, overhead time complexity model 818 would be: Tₒ(n, d)=(d²+d^{1/2}). The overhead time complexity model may be output by being displayed on display 820 of computer 802. Alternatively, the overhead time complexity model may be transmitted to a remote user over a network (not shown).

### Parallel Processing Performance Approximation Model Output Generation:

The discussion above details exemplary systems and methods to determine either (i) the time complexity determination model output or (ii) the overhead time complexity model output effects of parallel processing. In certain embodiments, these two models are combined to generate a parallel processing performance approximation model output.

FIG. 15 shows an exemplary parallel processing performance model generator (PPPMG) 1500, in one embodiment. For example, PPPMG 1500 is stored in memory 106, or 806, as computer readable instructions that when executed by processor 104, or 804, generates parallel processing performance model output 1502 (PPPMO) using a single processor 104, or 804. PPPMG 1500 may be a separate application running on computer 102, or 802, or may be for example a plug-in running in conjunction with a program installed on computer 102 or 802. In certain embodiments, PPPMG 1500 may be located on a separate computer, wherein the algorithm 108 and dataset 110 information is transferred over a network to the separate computer for analyzing.

PPPMG 1500 includes speedup approximation model generator 118 (as discussed above) and overhead time complexity model generator 912 (as discussed above) and generates parallel processing performance model output 1502.

PPPMG 1500 utilizes the concept that there are two broad system behaviors that may be found by changing the dataset size “d” per computational element while also changing the number of computational elements “n”: time complexity (i.e. discussed in FIGS. 1-7) and overhead time complexity (i.e. discussed in FIGS. 8-14).

Including overhead, the general maximum parallel performance of an algorithm changes to:

$$General Maximum Parallel Performance of an Algorithm \text{:} \\ {S}_{n} = \frac{{T}_{1}}{{T}_{n} + {T}_{o}} ⇒ Max ( {S}_{o} ( d , n ) ) = \frac{T ( d )}{T ( \frac{d}{n} ) + {T}_{o} ( nd )} \qquad Equation 7$$

where T(d) is the time complexity for a function with input dataset of size “d”;

$$T ( \frac{d}{n} )$$

is the time complexity for a function with input dataset of size “d” and divided between “n” processing elements, and Tₒ(nd) is the overhead time complexity for a function with input dataset of size “d” and divided between “n” processing elements.

Using the time complexity determination model generator 112, PPPMG 1500 determines the polynomial defining T(n, d). Further, using the overhead time complexity model generator 912, PPPMG 1500 may generate the overhead polynomial defining Tₒ(n, d). Accordingly, the parallel processing performance model 1502 may be determined and output by PPPMG 1500.

FIG. 16 depicts an exemplary method 1600 for generating a processing performance model. For example, method 1600 is performed using PPPMG 1500 as described above.

In step 1602, parallel performance model generator 1500 generates the time complexity determination model output. In one embodiment, step 1602 is performed as described in FIGS. 1-7 by speedup approximation model generator 112.

In step 1604, parallel performance model generator 1500 generates the overhead time complexity model output. In one embodiment, step 1602 is performed as described in FIGS. 8-14 by overhead time complexity model generator 912.

In step 1604, parallel performance model generator 1500 generates the parallel performance model by combining the speedup approximation model output generated in step 1602 and the overhead time complexity model output generated in step 1604.

### Serial Effects:

The term (1−p) in Amdahl's Law represents the serial portion of algorithm. This implies that a function is decomposed into serial and parallel portions. If an algorithm is functionally decomposed into its smallest functions, then each function can be tested for serialism or parallelism. The time complexity of the serial functions can be grouped separately from the parallel functions. Serialism is detected when any function's time complexity equals a constant value, that is, processing time is independent of dataset size. If no serial functions are detected then the constant equals zero. The serial constant processing time for a particular sub-function “gₓ( )” is noted as tₛ_{ₓ}, where x is the sub-function indicator. The parallel time complexity function for a particular sub-function “gₓ( )” is then noted as Tₓ(d) and the overhead time complexity function for a particular sub-function “gₓ( )” is noted as Tₒ_{ₓ}(d).

### Strong Scaling Speedup Prediction Model:

The total processing time for an algorithm is the serial time plus the parallel time. The sub-functions gₓ( ) represent the decomposed sub-functions used to separate serial from parallel parts of a function. The found time complexity function terms are then given for each decomposed sub-function of interest, that is f_{x,y}( ) meaning the y^{th} term of x^{th} sub-function. Therefore, speedup can now be defined as:

$$Strong Scaling Speedup Prediction Model \text{:} \\ \begin{matrix}S ( d , n ) = \frac{{\sum }_{h = 1}^{a} {t}_{{s}_{h}} + {\sum }_{i}^{b} {T}_{i} ( d )}{{\sum }_{h = 1}^{a} {t}_{{s}_{h}} + {\sum }_{i}^{b} ( {T}_{i} ( \frac{d}{n} ) + {T}_{{o}_{i}} ( nd ) )} \\ ≅ \frac{{\sum }_{h = 1}^{a} {t}_{{s}_{h}} + {\sum }_{i}^{b} {\sum }_{j = 1}^{n} {f}_{i , j} ( d )}{{\sum }_{h = 1}^{a} {t}_{{s}_{h}} + {\sum }_{i}^{b} ( {\sum }_{j}^{n} {f}_{i , j} ( \frac{d}{n} ) + {\sum }_{k}^{c} ( 0 ⋁ {f}_{{o}_{i , k}} ( nd ) ) )}\end{matrix} \qquad Equation 8$$

where a=the number of serial functions found; h=a particular serial sub-function; tₛ_{ₕ}=the constant serial processing time for a particular serial sub-function; h, i=a particular parallel sub-function; b=the number of parallel sub-function found; Tᵢ(d)=the time complexity function for the parallel sub-function “i” with a dataset size of “d”;

$${T}_{i} ( \frac{d}{n} ) = the time complexity function for the parallel sub \text{-} {function }^{″} {i}^{″} with a a dataset size {of }^{″} d \text{/} {n}^{″} ;$$

Tₒ_{ᵢ}(nd)=the time complexity function for the overhead sub-function “i” with a dataset size of “dn”; f_{i,j}(d)=the j^{th} term of the i^{th} parallel time complexity sub-function with a dataset size “d”;

$${f}_{i , j} ( \frac{d}{n} ) = the {j}^{th}$$

term of the parallel time complexity sub-function with a dataset size “d/n”; fₒ_{_{i,k}}(nd)=the k^{th} term of the i^{th} parallel time complexity sub-function with a dataset size “nd” “d”.

This means that when overhead exists, it dominates the equation because its value grows with n. When overhead is non-existent, the serial term, if it exists, dominates the equation because it is a constant and as T(d/n) decreases with n.

The maximum strong scaling speedup occurs at the point where the denominator is minimized. Since serial effects are a constant the denominator is minimized when:

$$Serial Effect on Maximum Speedup \text{:} \\ Min ( {\sum }_{i}^{b} {T}_{i} ( \frac{d}{n} ) + {\sum }_{j}^{c} {T}_{{o}_{j}} ( nd ) ) \qquad Equation 9$$

Accordingly, the Maximum strong scaling speedup prediction model becomes:

$$Maximum Strong Scaling Speedup Prediction Model \text{:} \\ Max ( S ( d , n ) ) = \frac{{\sum }_{h = 1}^{a} {t}_{s , h} + {\sum }_{i}^{b} {T}_{i} ( d )}{{\sum }_{h = 1}^{a} {t}_{s , h} + Min ( {\sum }_{i}^{b} {T}_{i} ( \frac{d}{n} ) + {\sum }_{j}^{c} {T}_{{o}_{j}} ( nd ) )} \qquad Equation 10$$

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for generating a prediction of parallel processing of an algorithm having a dataset capable of being subdivided, using a system comprising a processor and memory, the method comprising the steps of:
generating a time complexity search table comprising a plurality of columns and a plurality of rows, each column comprising an approximation header defining a polynomial which defines a time complexity of the algorithm and each row of each column defining the time complexity value of the respective polynomial for a plurality of dataset multiplications;
generating a time complexity comparison column defining plurality of values of the wall clock time required to execute the algorithm for the plurality of dataset multiplications;
determining a time complexity approximation column within the time complexity search table defining the column having the highest time complexity values that do not exceed the values of the time complexity comparison column;
storing the header of the time complexity approximation column within the memory; and
generating a time complexity determination model output comprising the header of the time complexity approximation column stored within the memory.

2. The method of claim 1, wherein the step of generating a time complexity determination model comprises:
determining a progressively more accurate time complexity determination model output by repeating, until a predefined threshold is met, the steps of:
determining if the predefined threshold is met;
generating an additional time complexity comparison column by subtracting the values of the time complexity approximation column from the values of the time complexity comparison column;
determining an additional time complexity approximation column of the time complexity search table defining the column having the highest time complexity values that do not exceed the values of the additional time complexity comparison column; and
storing the header of the additional time complexity approximation column within the memory; and
generating the time complexity determination model output comprising the headers stored within the memory;
wherein the predefined threshold defines a difference required, between the additional time complexity approximation column and the additional time complexity comparison column, to determine when the time complexity determination model is adequate.

3. The method of claim 2, wherein the predefined threshold is met when the difference between the additional time complexity approximation column and the additional time complexity comparison column is zero.

4. The method of claim 1, further comprising displaying the time complexity determination model output to a user.

5. The method of claim 4, wherein the step of displaying comprises transmitting the time complexity determination model output to a remote user over a network.

6. A method for generating a prediction of algorithmic overhead of parallel processing of an algorithm having a dataset capable of being subdivided, using a system comprising a processor and memory, the method comprising:
generating an overhead time complexity search table comprising a plurality of columns and a plurality of rows, each column comprising an overhead time complexity approximation header defining a polynomial which defines an overhead of the algorithm and each row of each column defining the overhead time complexity value of the respective polynomial for a plurality of dataset divisions;
generating an overhead time complexity comparison column defining plurality of values of the additional overhead wall clock time required to execute the algorithm for the plurality of dataset divisions;
determining an overhead approximation column within the overhead time complexity search table defining the column having the highest algorithmic overhead time complexity values that do not exceed the values of the overhead time complexity comparison column;
storing the header of the overhead approximation column within the memory; and
generating an overhead time complexity approximation model output comprising the header of the overhead time complexity approximation column stored within the memory.

7. The method of claim 6, wherein the step of generating an overhead time complexity comparison column comprises:
determining a progressively more accurate overhead time complexity approximation model output by repeating, until a predefined threshold is met, the steps of:
determining if the predefined threshold is met;
generating an additional overhead time complexity comparison column by subtracting the values of the overhead time complexity approximation column from the values of the overhead time complexity comparison column;
determining an additional overhead time complexity approximation column of the overhead search table defining the column having the highest algorithmic overhead values that do not exceed the values of the additional overhead time complexity comparison column; and
storing the header of the additional overhead time complexity approximation column within the memory; and
generating the overhead time complexity approximation model output comprising the headers stored within the memory;
wherein the predefined threshold defines a difference required, between the additional overhead time complexity approximation column and the additional overhead time complexity comparison column, to determine when the overhead time complexity approximation model is adequate.

8. The method of claim 7, wherein the predefined threshold is met when the difference between the additional overhead time complexity approximation column and the additional overhead time complexity comparison column is zero.

9. The method of claim 6, further comprising displaying the overhead time complexity approximation model output to a user.

10. The method of claim 9, wherein the step of displaying comprises transmitting the overhead time complexity approximation model output to a remote user over a network.

11. The method of claim 6 wherein the step of generating an overhead time complexity comparison column comprises completing a loopback test to determine the overhead wall clock time for a plurality of dataset divisions.

12. The method of claim 1 further comprising generating an overhead performance model by performing the steps of:
generating an overhead time complexity search table comprising a plurality of columns and a plurality of rows, each column comprising an overhead time complexity approximation header defining a polynomial which defines the overhead time complexity of the algorithm and each row of each column defining an algorithmic overhead time complexity value of the respective polynomial for a plurality of dataset divisions;
generating an overhead time complexity comparison column defining plurality of values of the additional overhead wall clock time required to execute the algorithm for the plurality of dataset divisions;
determining an overhead time complexity approximation column within the overhead time complexity search table defining the column having the highest algorithmic overhead time complexity values that do not exceed the values of the overhead time complexity comparison column;
storing the header of the overhead time complexity approximation column within the memory; and
generating an overhead time complexity approximation model output comprising the header of the overhead approximation column stored within the memory.

13. The method of claim 12 further comprising generating a parallel processing performance model by combining the time complexity determination model and the overhead time complexity approximation model.

14. The method of claim 13 wherein the step of generating a parallel processing performance model comprises combining the time complexity determination model and the overhead approximation model in the format defined by:
$$\begin{matrix}S ( d , n ) = \frac{{\sum }_{h = 1}^{a} {t}_{{s}_{h}} + {\sum }_{i}^{b} {T}_{i} ( d )}{{\sum }_{h = 1}^{a} {t}_{{s}_{h}} + {\sum }_{i}^{b} ( {T}_{i} ( \frac{d}{n} ) + {T}_{{o}_{i}} ( nd ) )} \\ ≅ \frac{{\sum }_{h = 1}^{a} {t}_{{s}_{h}} + {\sum }_{i}^{b} {\sum }_{j = 1}^{n} {f}_{i , j} ( d )}{{\sum }_{h = 1}^{a} {t}_{{s}_{h}} + {\sum }_{i}^{b} ( {\sum }_{j}^{n} {f}_{i , j} ( \frac{d}{n} ) + {\sum }_{k}^{c} ( 0 ⋁ {f}_{{o}_{i , k}} ( nd ) ) )}\end{matrix}$$
